(19) United States
(12) Patent Application Publication
(10) Pub. No.: US 2005/0060137 A1
(43) Pub. Date: Mar. 17, 2005

(54) Method and apparatus to emulate an execution environment

(76) Inventors: Mark S. Lanus, Tempe, AZ (US); Douglas L. Sandy, Chandler, AZ (US)

Correspondence Address: MOTOROLA, INC., Corporate Law Department - #56-238, 3102 North 56th Street, Phoenix, AZ, 85018, US

(21) Appl. No.: 10/661,911

(22) Filed: Sep. 12, 2003

(51) Int. Cl. G06F 9/455; G06F 9/45

(52) U.S. Cl. 703/23; 717/138

(57) ABSTRACT

A method and apparatus include a real-time kernel (223) provides an emulated subset of WIN32 execution environment services (219). The real-time kernel initializes computer hardware (222) and software. Executable (206) is loaded into memory (214), and memory is allocated to executable, where the executable is programmed to execute in a WIN32 execution environment (116). The real-time kernel (223) permits execution of the executable in an emulated WIN32 execution environment (215), where the emulated WIN32 execution environment (215) utilizes the emulated subset of WIN32 execution environment services (219). The executable (206) operates real-time in the emulated WIN32 execution environment (215).

### BACKGROUND OF THE INVENTION

Some applications require the real-time execution of a computer program. This is particularly true in embedded applications such as medical imaging, signal intelligence, industrial automation, and the like. Prior art software development packages such as QNX from QNX Software Systems Ltd., Ottawa, Ontario, and VxWorks from Wind River International, Alameda, Calif., have their own proprietary development software and real-time operating system (RTOS). These prior art software packages allow the development of real-time executables. However, these executables will run only on their respective proprietary RTOS's. Presently, most software is developed in a Microsoft Windows® development model using development programs such as Microsoft Visual Studio®, and the like. Since Windows operating systems are ubiquitous, most programmers are familiar with Windows development tools where they develop programs to run in a Windows environment. Software developed using the Windows programming model is designed to execute in the Windows execution environment, which is a not a real-time execution environment (i.e. not a RTOS). In instances requiring real-time execution, the development of real-time executable software using a Windows development model is not practical using prior art software and techniques. This requires software developers desiring real-time executables to use less familiar, prior art, proprietary software development tools and RTOS's. This often requires the use of proprietary hardware as well that is not compatible with more ubiquitous hardware environments, such as Intel based x86 architecture. This can create inefficiency and higher cost in the creation of embedded, real-time software.

Accordingly, there is a significant need for an apparatus and method that overcomes the disadvantages of the prior art discussed above.

### BRIEF DESCRIPTION OF THE DRAWINGS

Referring to the drawing:

FIG. 1 depicts a block diagram of a prior art programming model;

FIG. 2 depicts a block diagram of a programming model in accordance with an embodiment of the invention;

FIG. 3 depicts a block diagram of a real-time kernel in accordance with an embodiment of the invention;

FIG. 4 depicts a computer network in accordance with an embodiment of the invention;

FIG. 5 depicts a computer network in accordance with another embodiment of the invention; and

FIG. 6 illustrates a flow diagram in accordance with an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known software blocks have not been shown in detail in order not to obscure the invention.

For clarity of explanation, the embodiments of the present invention are presented, in part, as comprising individual functional blocks. The functions represented by these blocks may be provided through the use of either shared or dedicated hardware and/or software, including, but not limited to, hardware capable of executing software. The present invention is not limited to implementation by any particular set of elements (hardware and/or software), and the description herein is merely representational of one embodiment.

The term “executable” as used herein is to be interpreted broadly as software that exists in a state that can be run on a computer. An executable can be in binary form, pseudo code, and the like. These executables are intended to be executed by a processor in a manner consistent with the present invention. Also, the present invention can refer to various processes interacting with humans or other processes. Those skilled in the art will recognize that human interaction with any of the foregoing programs or processes may be accomplished, for example, using a graphical user interface system to display relevant data and to permit human users to exchange commands and data with the associated programs or processes.

Software blocks that perform embodiments of the present invention can be part of computer program modules comprising computer instructions, such control algorithms, that are stored in a computer-readable medium such as memory. Computer instructions can instruct processors to perform any methods described below. In other embodiments, additional modules could be provided as needed.

FIG. 1 depicts a block diagram of a prior art programming model 100. As shown in FIG. 1, in the prior art an executable 106 is created in a Windows development model 102. Executable 106 can be a file that contains a program that is capable of being executed on a computer. Windows development model 102 can be a software package, such as Microsoft Visual Studio® from Microsoft Corporation, and the like. Generally, Windows development model 102 allows a software developer to write software code through the use of an editor, compile and link the code. Debugging can also be performed on the code.

Windows development model 102 also allows the linking of any number of libraries to executable 106. Libraries can be collections of one or more subroutines or functions, any of which can be called when needed by a program. For example, a statically linked library 108 can be incorporated into executable 106 or a dynamically linked library 110 can be referenced in executable 106. Subsequent to editing, compiling, debugging and linking libraries, executable 106 is generated through Windows development model 102.

Executable 106 is transferred to prior art computing model 104 for execution. Prior art computing model 104 can include computer hardware 122, which comprises processor 112 and memory 114. Included in memory 114 is windows kernel 124, which can be part of an operating system such as Microsoft Windows operating system, for example, Microsoft Windows 95, 98, 2000, NT, XP, and the like. Windows kernel 124 is part of WIN32 execution environment 116, which comprises windows kernel 124, WIN32 application program interface (API), WIN32 flat memory model architecture, and the like. Windows kernel 124 can comprise any number of WIN32 execution environment services 118, which can include, for example, thread and process handling, message handling, interrupt handling, exception handling, memory management, device drivers, Direct X, graphical user interface drivers, and the like.

The use of windows kernel 124 in prior art computing model 104 causes non real-time execution 120 of executable 106. In an embodiment, non real-time execution 120 can mean that the latency associated with any task performed by executable 106 is not deterministic and/or bounded. Non-real time execution 120 can also imply that the computer is not able to keep up with some external process (for example, to present visualizations of the weather as it constantly changes).

As is known in the art, Windows operating systems do not run executables in real-time as Windows is not a RTOS. This is due in part to multithreading, multitasking and message structure required and the numerous applications that are run at simultaneously using Windows operating system. Therefore, when executable 106 is run using windows kernel 124 it will not operate in a real-time, deterministic manner. This makes executables created using Windows development model 102 in the prior art not useful for embedded applications and/or applications requiring real-time execution.

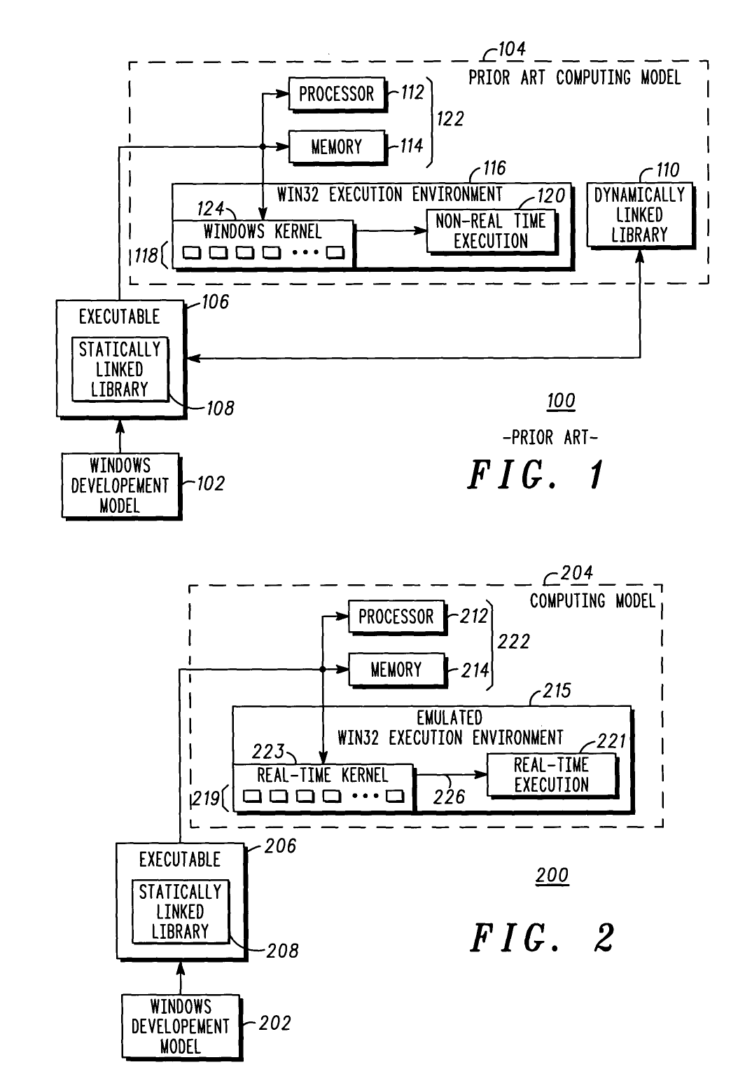

FIG. 2 depicts a block diagram of a programming model 200 in accordance with an embodiment of the invention. As shown in FIG. 2, an executable 206 is created in a Windows development model 202. Executable 206 can be a file that contains a program that is capable of being executed on a computer. Windows development model 202 can be a software package, such as Microsoft Visual Studio® from Microsoft Corporation, and the like. Generally, Windows development model 202 allows a software developer to write software code through the use of an editor, compile and link the code. Debugging can also be performed on the code.

In the embodiment shown, Windows development model 202 allows the linking of any number of statically linked libraries to executable 206. Statically linked library 208 can be a collection of one or more functions or subroutines, any of which can be called when needed by a program. In an embodiment, statically linked library 208 is incorporated into the code of executable 206. For example, statically linked library 108 can be a domain specific application library comprising subroutines tailored to a specific application. Examples of statically linked libraries include, but are not limited to, Vector Signal Image Processing Library (VSIPL), Intel® math kernel library, image processing libraries, signal processing libraries, and the like. Subsequent to editing, compiling, debugging and linking libraries, executable 206 is generated through Windows development model 202.

In an embodiment, executable 206 can be for any real-time application. For example and without limitation, executable 206 can be for medical imaging, signal intelligence, industrial automation and control, high-performance computing, and the like. In an embodiment, executable 206 can be for an embedded application, such as medical imaging, automotive engine control units, and the like. In another embodiment, executable 206 can be for a non-embedded application.

In an embodiment, executable 206 can be transferred to computing model 204 for execution. Computing model 204 can include computer hardware 222, which comprises processor 212 and memory 214. In an embodiment, computer hardware 222, particularly processor 212, can be x86-based architecture computer hardware. For example, and without limitation, computer hardware can include an Intel® based processor such as a processor from the Pentium® family (Pentium, Pentium 2, 3, 4), Celeron® family, Xeon™ family, and the like. In another embodiment, computer hardware can be Advanced Micro Devices (AMD), Transmeta™, and the like processors having x86-based architecture.

Memory 214 can comprise control algorithms, and can include, but is not limited to, random access memory (RAM), read only memory (ROM), flash memory, electrically erasable programmable ROM (EEPROM), and the like. Memory 214 can contain stored instructions, tables, data, and the like, to be utilized by processor 212.

Stored in memory 214 in computing model 204 is real-time kernel 223. Real-time kernel 223 creates and is part of emulated WIN32 execution environment 215, which can comprise an emulated WIN32 application program interface (API), WIN32 flat memory model architecture, and the like.

Real-time kernel 223 can comprise any number of emulated subset of WIN32 execution environment services 219. Each of emulated subset of WIN32 execution environment services 219 are not duplicates of analogous WIN32 execution environment services 118 found in WIN32 execution environment 116, but are emulated services designed specifically to operate with real-time kernel 223. The prior art WIN32 execution environment services 118 are designed to work with the myriad of other services within the WIN32 execution environment 116 that are not present in emulated WIN32 execution environment 215. For example, WIN32 execution environment services 118 are designed to work with device drivers, graphical user interface, and the like, which are not present in emulated subset of WIN32 execution environment services 219. Therefore, emulated subset of WIN32 execution environment services 219 are streamlined to operate more efficiently to provide real-time execution 221 of executable in emulated WIN32 execution environment 215.

The use of real-time kernel 223 in computing model 204 permits real-time execution 221 of executable 206. In an embodiment, real-time execution 221 can mean that the latency associated with any software task is deterministic and/or bounded.

A feature of real-time kernel 223 that permits real-time execution 221 of executable 206 is that real-time kernel 223 is single threaded 226. A thread is placeholder information associated with a single use of a program. From the point-of-view of executable 206, a thread is the information needed to serve one individual user or a particular service request. In an embodiment, thread information can be kept by storing it in a special data area and putting the address of that data area in a register. In an embodiment, real-time kernel 223 is not subject to multiple uses of executable 206 by multiple users (multithreading or multitasking), it is able to implement real-time execution 221 of executable.

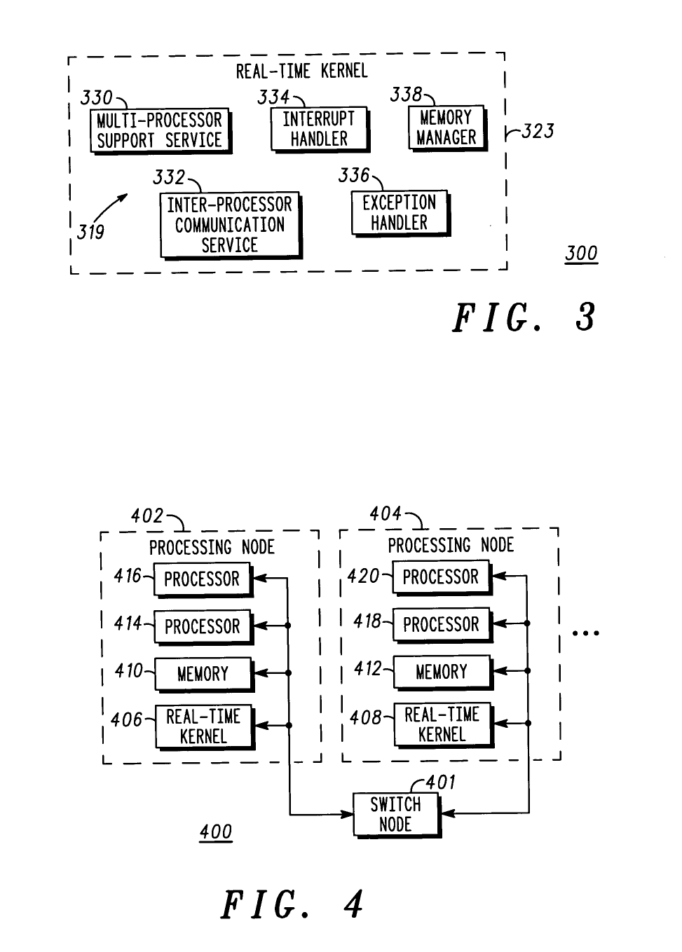

FIG. 3 depicts a block diagram 300 of a real-time kernel 323 in accordance with an embodiment of the invention. As shown in FIG. 3, real-time kernel 323 is comprised of an emulated subset of WIN32 execution environment services 319. The emulated subset of WIN32 execution environment services 319 depicted in the embodiment of FIG. 3 are exemplary and not meant to be limiting of the invention. It is understood by those skilled in the art that fewer or greater number of emulated subset of WIN32 execution environment services 319 are within the scope of the invention.

Multiprocessor support service 330 provides real-time kernel 323 with the ability to use multiple processors in the real-time execution 221 of executable 206. This can allow the distribution of tasks among any number of processors so as to more efficiently permit real-time execution 221 of executable.

Inter-processor communication service 332 provides real-time kernel 323 the ability to communicate with any number of processors in a network environment. In an embodiment, inter-processor communication service 332 can be Windows Socket (Winsock) for communication using standard transmission control protocol/internet protocol (TCP/IP), Ethernet, and the like. In another embodiment, inter-processor communication service 332 can be an Infiniband verb layer. Other inter-processor communication services are within the scope of the invention.

Interrupt handler 334 provides real-time kernel 223 the ability to allow processor 212 to service interrupts. Exception handler 336 provides real-time kernel 223 the ability to handle exceptions during the real-time execution 221 of executable 206. Memory manager 338 allows real-time kernel 223 the ability to allocate memory in computing model 204 to load and execute executable 206. Other services can include such things as a loader service to permit real-time kernel-223 to load executable 206 into memory.

FIG. 4 depicts a computer network 400 in accordance with an embodiment of the invention. The computer network 400 depicted in FIG. 4 is in a “star” configuration with a central switch node 401 and any number of processing nodes 402, 404. For example, and without limitation, computer network 400 can be a bladed architecture, backplane-based computer network. In the most general sense, a blade in a network is an industry-standard computer delivered on a single processing node that can be plugged as a module into a chassis. In various embodiments of the invention, a chassis may have anywhere from eight to twenty-four payload slots for receiving processing nodes and therefore accept from eight to twenty-four such processing nodes or “blades.”

Processing nodes 402, 404 can add functionality to computer network 400 through the addition of processors, memory, storage devices, I/O elements, and the like. In other words, processing node 402, 404 can include any combination of processors, memory, storage devices, I/O elements, and the like, to give computer network 400 the functionality desired by a user. Other configurations for computer network 400 can include, but are not limited to, dual-star configurations, distributed switch architecture configurations, and the like. Any computer network configuration is within the scope of the invention.

In the embodiment depicted in FIG. 4, processing node 402 comprises two processors 414, 416, memory 410 and real-time kernel 406 stored in memory 410. Analogously, processing node 404 comprises two processors 418, 420, memory 412 and real-time kernel 408 stored in memory 412. Although two processors are depicted in each processing node, any number of processors are within the scope of the invention.

Real-time kernel 406 permits execution of executable 206 in at least one of processors 414, 416 on processing node 402. Executable 206 operates real-time in emulated WIN32 execution environment 215. Analogously, real-time kernel 408 permits execution of executable 206 in at least one of processors 418, 420 on processing node 404, where executable 206 operates real-time in emulated WIN32 execution environment 215.

Inter-processor communication service 332 allows each real-time kernel 406, 408 the ability to communicate with other processors in computer network 400. Also, multi-processor support service 330 allows real-time kernel 406, 408 with the ability to use multiple processors in the real-time execution 221 of executable 206 on each processing node 402, 404.

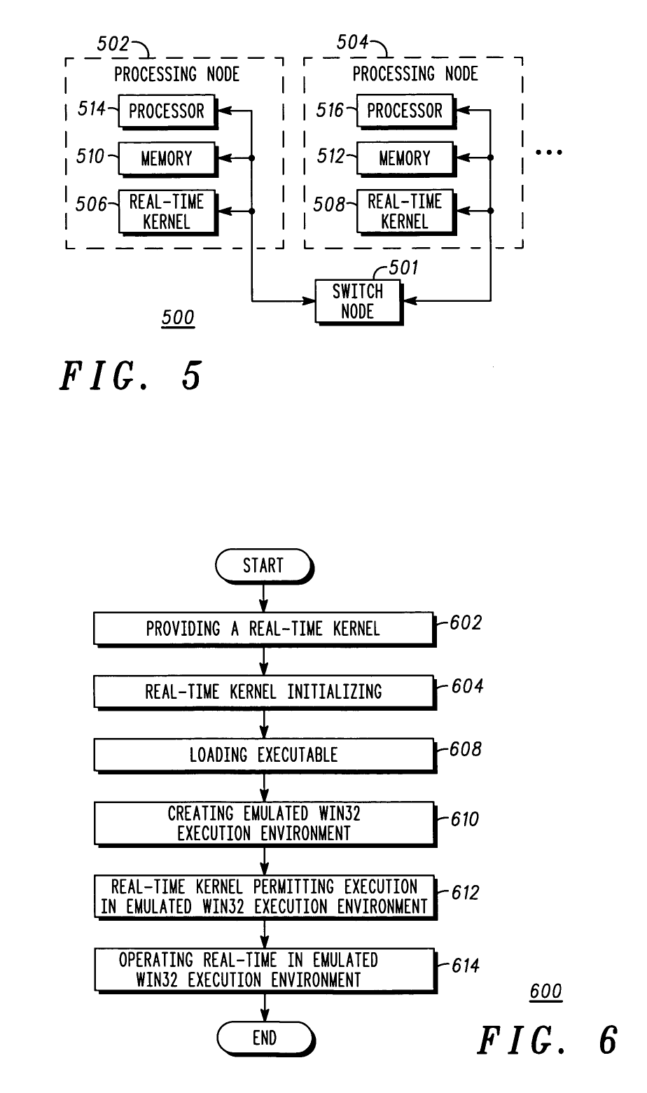

FIG. 5 depicts a computer network 500 in accordance with another embodiment of the invention. The computer network 500 depicted in FIG. 5 is in a “star” configuration with a central switch node 501 and any number of processing nodes 502, 504. For example, and without limitation, computer network 500 can be a bladed architecture, backplane-based computer network.

In the embodiment depicted in FIG. 5, processing node 502 comprises a processor 514, memory 510 and real-time kernel 506 stored in memory 510. Analogously, processing node 504 comprises a processor 516, memory 512 and real-time kernel 508 stored in memory 512.

Real-time kernel 506 permits execution of executable 206 in processor 514 on processing node 502. Executable 206 operates real-time in emulated WIN32 execution environment 215. Analogously, real-time kernel 508 permits execution of executable 206 in processor 516 on processing node 504, where executable 206 operates real-time in emulated WIN32 execution environment 215.

Inter-processor communication service 332 allows each real-time kernel 506, 508 the ability to communicate with other processors in the computer network 500. Also, multi-processor support service 330 allows real-time kernel 506, 508 with the ability to use multiple processors in the real-time execution 221 of executable 206 on each processing node 502, 504.

FIG. 6 illustrates a flow diagram 600 in accordance with an embodiment of the invention. In step 602, a real-time kernel 223 is provided, where the real-time kernel comprises a subset of WIN32 execution environment services 219. In step 604, real-time kernel 223 initializes computer hardware222 and software components. In step 608, executable 206 is loaded into memory 214 with memory being allocated to executable 206 as specified in executable's header portion. In an embodiment, executable 206 can be programmed to execute in a WIN32 execution environment 116.

In step 610, real-time kernel 223 creates emulated WIN32 execution environment 215. In step 612, real-time kernel 223 permits execution of executable 206 in emulated WIN32 execution environment 215. In an embodiment, emulated WIN32 execution environment 215 utilizes emulated subset of WIN32 execution environment services 219.

In step 614, executable operates real-time in emulated WIN32 execution environment 215. In other words; real-time kernel 223 creates an emulated WIN32 execution environment 215 to allow real-time execution 221 of executable 206.

While we have shown and described specific embodiments of the present invention, further modifications and improvements will occur to those skilled in the art. It is therefore to be understood that appended claims are intended to cover all such modifications and changes as fall within the true spirit and scope of the invention.

1. A method, comprising:
providing a real-time kernel;
loading an executable into memory, wherein the memory is allocated for the executable, and wherein the executable is programmed to execute in a WIN32 execution environment;
the real-time kernel permitting execution of the executable in an emulated WIN32 execution environment, wherein the emulated WIN32 execution environment utilizes an emulated subset of WIN32 execution environment services; and
the executable operating real-time in the emulated WIN32 execution environment.

2. The method of claim 1, wherein the emulated subset of WIN32 execution environment services comprises a multi-processor support service.

3. The method of claim 1, wherein the emulated subset of WIN32 execution environment services comprises an inter-processor communication service.

4. The method of claim 1, wherein the emulated subset of WIN32 execution environment services comprises an interrupt handler.

5. The method of claim 1, wherein the emulated subset of WIN32 execution environment services comprises an exception handler.

6. The method of claim 1, wherein the emulated subset of WIN32 execution environment services comprises a memory manager.

7. The method of claim 1, further comprising the real-time kernel executing on computer hardware, wherein the computer hardware is x86-based architecture computer hardware.

8. The method of claim 1, wherein the real-time kernel is single threaded.

9. A real-time kernel, comprising:—
an interrupt handler;
an exception handler; and
a memory manager, wherein the real-time kernel permits execution of an executable in an emulated WIN32 execution environment, wherein the executable is programmed to execute in a WIN32 execution environment, and wherein the executable operates real-time in the emulated WIN32 execution environment.

10. The real-time kernel of claim 9, wherein the real-time kernel is single threaded.

11. The real-time kernel of claim 9, wherein the wherein the real-time kernel executes on computer hardware, wherein the computer hardware is x86-based computer hardware.

12. An apparatus, comprising:
a processor;
a memory; and
a real-time kernel having a subset of WIN32 execution environment services stored in the memory, wherein the real-time kernel permits execution of an executable in an emulated WIN32 execution environment on the processor, wherein the executable is programmed to execute in a WIN32 execution environment, and wherein the executable operates real-time in the emulated WIN32 execution environment.

13. The apparatus of claim 12, wherein the processor is an x86-based architecture processor.

14. The apparatus of claim 12, wherein the real-time kernel is single threaded.

15. A method, comprising:
providing a real-time kernel;
loading an executable into memory, wherein the memory is allocated for the executable, and wherein the executable is programmed to execute in a WIN32 execution environment;
the real-time kernel creating an emulated WIN32 execution environment which permits execution of the executable in an emulated WIN32 execution environment, wherein the emulated WIN32 execution environment utilizes an emulated subset of WIN32 execution environment services; and
the executable operating real-time in the emulated WIN32 execution environment.

16. The method of claim 15, wherein the emulated subset of WIN32 execution environment services comprises a multi-processor support service.

17. The method of claim 15, wherein the emulated subset of WIN32 execution environment services comprises an inter-processor communication service.

18. The method of claim 15, wherein the emulated subset of WIN32 execution environment services comprises an interrupt handler.

19. The method of claim 15, wherein the emulated subset of WIN32 execution environment services comprises an exception handler.

20. The method of claim 15, wherein the emulated subset of WIN32 execution environment services comprises a memory manager.

21. The method of claim 15, wherein the real-time kernel is single threaded.

22. A computer network, comprising:
a plurality of processors;
a memory; and
a real-time kernel having a subset of WIN32 execution environment services stored in the memory, wherein the real-time kernel permits execution of an executable in an emulated WIN32 execution environment on at least one of the plurality of processors, wherein the executable is programmed to execute in a WIN32 execution environment, and wherein the executable operates real-time in the emulated WIN32 execution environment.

23. The computer network of claim 22, wherein the plurality of processors are x86-based architecture processors.

24. The apparatus of claim 22, wherein the real-time kernel is single threaded.

25. A computer network, comprising:
a plurality of processors;
a plurality of memories corresponding to each of the plurality of processors; and
a real-time kernel having a subset of WIN32 execution environment services stored in each of the plurality of memories, wherein the real-time kernel permits execution of an executable in an emulated WIN32 execution environment on one of the plurality of processors, wherein the executable is programmed to execute in a WIN32 execution environment, and wherein the executable operates real-time in the emulated WIN32 execution environment.

26. The computer network of claim 25, wherein the plurality of processors are x86-based architecture processors.

27. The apparatus of claim 25, wherein the real-time kernel is single threaded.

28. A method of operating a computer network, comprising:
providing a real-time kernel;
loading an executable into memory, wherein the memory is allocated for the executable, and wherein the executable is programmed to execute in a WIN32 execution environment;
the real-time kernel permitting execution of the executable in an emulated WIN32 execution environment, wherein the emulated WIN32 execution environment utilizes an emulated subset of WIN32 execution environment services; and
the executable operating real-time in the emulated WIN32 execution environment.

29. A computer-readable medium containing computer instructions for instructing a processor to perform a method of operating an apparatus, the instructions comprising:
providing a real-time kernel;
loading an executable into memory, wherein the memory is allocated for the executable, and wherein the executable is programmed to execute in a WIN32 execution environment;
the real-time kernel permitting execution of the executable in an emulated WIN32 execution environment, wherein the emulated WIN32 execution environment utilizes an emulated subset of WIN32 execution environment services; and
the executable operating real-time in the emulated WIN32 execution environment.

30. The computer-readable medium of claim 29, wherein the computer hardware is x86-based architecture computer hardware.

31. The computer-readable medium of claim 29, wherein the real-time kernel is single threaded.

32. A computer-readable medium containing computer instructions for instructing a processor to perform a method of operating a computer network, the instructions comprising:
providing a real-time kernel;
the real-time kernel initializing the computer network;
loading an executable into memory, wherein the memory is allocated for the executable, and wherein the executable is programmed to execute in a WIN32 execution environment;
the real-time kernel permitting execution of the executable in an emulated WIN32 execution environment, wherein the emulated WIN32 execution environment utilizes an emulated subset of WIN32 execution environment services; and
the executable operating real-time in the emulated WIN32 execution environment.
